(19) United States
(12) Patent Application Publication
(10) Pub. No.: US 2014/0076487 A1
(43) Pub. Date: Mar. 20, 2014

(54) METHOD OF MAKING MULTI-COLORED PRINTED SURFACES ON FLEXIBLE IMPLEMENT GRIPS

(71) Applicants: Wen-Chen Su, Pinehurst, NC (US); Alex Lee Walls, Laurinburg, NC (US); Min-Chia Wang, Tainan (TW); Meng-Feng Tsai, Nan-Bao (TW)

(72) Inventors: Wen-Chen Su, Pinehurst, NC (US); Alex Lee Walls, Laurinburg, NC (US); Min-Chia Wang, Tainan (TW); Meng-Feng Tsai, Nan-Bao (TW)

(73) Assignee: Eaton Corporation, Cleveland, OH (US)

(21) Appl. No.: 13/615,905

(22) Filed: Sep. 14, 2012

(51) Int. Cl. B32B 37/24; B32B 38/04

(52) U.S. Cl. 156/245

(57) ABSTRACT

A method of forming a flexible implement grip utilizing a cured underlist. A sleeve is formed of uncured sheet stock laminated with a carrier having a design thereon of heat transferable colored ink. The laminate is cut to a pattern, wrapped on a core bar and heated in a mold with textured/embossed cavities. The design is heat transferred to the sheet stock in the molding and upon removal from the mold, the carrier and core bar are removed to leave a seamless tubular sleeve with the colored design on the outer surface. The sleeve is then assembled on the underlist and adhesively secured thereon forming a finished grip.

### BACKGROUND

The present disclosure relates to flexible grips for installation on the handle of an implement or tool such as a hammer, hatchet or other hand tool, or handles of sporting implements such as tennis rackets and golf clubs. In particular, the present disclosure relates to multi-colored designs printed on the surface of the grip and particularly a rubber based golf club grip. The market for golf club grips has required that the grip maintain a resilient surface, preferably textured for grip enhancement, and has further required colored designs or logos printed on the surface of the grip for enhanced visual appeal.

However, in providing colored designs or logos on the surface of a golf club grip, problems have been encountered in manufacturing the grip inasmuch as the printing process has become complicated and costly. Additionally, problems have been encountered in the robustness or wearability of the colored design or logo printed on the surface of the grip and rapid wear removal of the printed design or logo during usage of the golf club.

Heretofore, the colored ink for the desired design or logo has been applied to the rubber base of the grip in a semi-cured state and placed in a mold for final curing. Alternatively, the colored design or logo has been applied to a sheet of material which is cured with the colored ink thereon and then cut to pattern and wrapped onto the rubber grip and secured thereon by adhesives. This has resulted in a grip with a longitudinal seam which has been undesirable and difficult to subdue on the finished grip thereby reducing visual appeal.

Thus, it has long been desired to provide a way or means of improving the retention of multi-colored designs or logos on the surface of an implement grip such as a golf grip in a manner which improves the life of the design or logo on the grip in use and yet provides an economical or relatively low cost manner of manufacturing, provides the desired softness and textured surface required for user appeal in the market place.

### SUMMARY

The present disclosure describes a method for making a flexible implement grip and particularly a golf club grip having a molded rubber base or underlist with a flexible textured skin or sheath having a colored design and/or logo cured on the surface thereof to provide improved durability of the colored design or logo in use on the golf club. The outer skin or sheath is formed from an uncured layer or substrate of thermosetting or thermoplastic elastomer with a carrier having curable colored ink thereon laminated to the substrate. In a version having the substrate formed of thermosetting elastomer, the laminate is then wrapped about a core bar and inserted into a mold having textured and/or embossed surfaces provided in the mold cavity. The laminate is then heat and compression cured in the mold which causes heat transfer of the colored ink design to the substrate. Upon removal of the laminate from the mold, the core bar is removed leaving a seamless tubular sheath or skin with the colored design and/or logo cured thereon; and, the carrier is then removed from the surface of the tubular skin. In a version having the substrate formed of thermoplastic elastomer, the laminate is wrapped on a core bar and heated to effect transfer of the thermal ink onto the substrate. The seamless tubular skin is then assembled over the cured base or underlist of the grip and secured thereon such as by adhesive bonding. The method of the present disclosure thus provides a flexible tubular skin or sheath which may be readily assembled over a non-round or non-symmetric implement or golf club grip inasmuch as the relatively thin flexible cured sheath readily conforms to the shape of the molded underlist. The method of the present disclosure thus provides a simple relatively low cost technique for fabricating a flexible implement grip and provides a colored design or logo cured thereon having improved wear resistance and robustness during usage.

### BRIEF DESCRIPTION OF THE DRAWINGS

FIG. 1 is a cross-section of a molded base or underlist for a golf club grip taken along section indicating lines 1-1 of FIG. 8;

FIG. 2 is perspective view of cut patterns for the skin and the curable colored ink carrier;

FIG. 3 is a perspective view of the cut patterns of FIG. 2 installed in a fixture for lamination;

FIG. 4 is a perspective view showing the skin laminate prepared for wrapping about a core bar;

FIG. 5 shows the core bar with wrapped skin inserted in a mold having multiple cavities;

FIG. 6 is a perspective view of the cured skin on a core bar after removal from the mold of FIG. 5;

FIG. 7 shows the skin of FIG. 6 after removal of the core bar;

FIG. 8 is a perspective view of the cured skin positioned for assembly onto the underlist;

FIG. 9 is a perspective view of a completed grip after assembly of the skin onto the underlist; and,

FIG. 10 is a block flow diagram of the method of the present disclosure.

### DETAILED DESCRIPTION

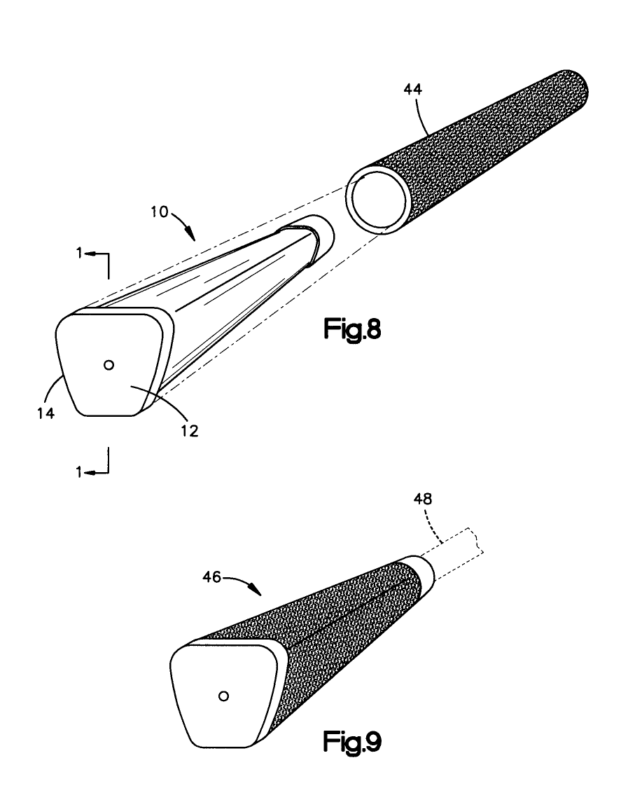

Referring to FIGS. 1 and 8, an underlist or base for an implement grip in the form of a golf club grip is illustrated in cross-section and perspective as denoted generally at 10 and has a generally tubular configuration with one end 12 closed and slightly flanged at 14 with a similar flange 16 formed at the end opposite the closed end 12. The internal diameter 18 of the underlist 10 is sized to permit assembly over the handle or shaft of the implement such as a tubular shaft of a golf club. In the present practice, the underlist or base 10 is formed of one of elastomeric and polymeric materials such as natural rubbers, synthetic rubbers, styrene butadiene rubber or ethylene propylene diene monomer or other suitable materials having the desired softness and flexibility for use in a golf club grip. The underlist 10 may also be formed of foam material such as ethylene vinyl acetate (EVA) foam, thermoplastic elastomer (TPE) foam and elastomeric foam material. As is well known in the manufacture of golf club grips, the underlist 10 may be vulcanized by compression molding with a mandrel or insert which is then removed after curing.

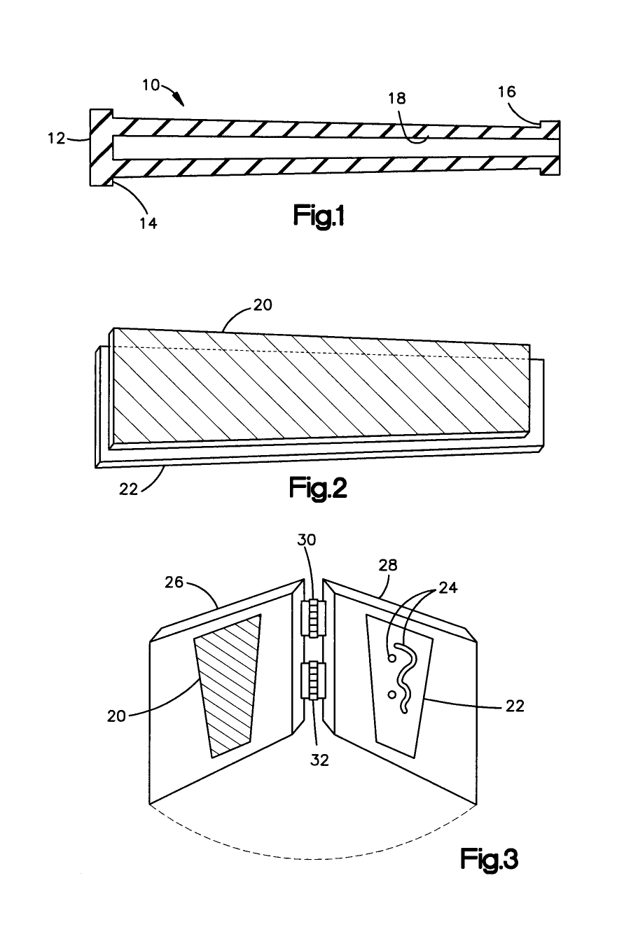

Referring to FIG. 2, sheet stock 20 of a desired thickness is provided in an uncured state for a tubular sheath or skin and may be chosen from any of the materials suitable for providing the desired surface properties for the grip and compatibility with bonding to the underlist 10. The stock employed for the skin may be of the same or different material as the underlist 10. In the present practice, where the skin sheet stock is formed of thermosetting elastomer, it has been found satisfactory to employ one of (i) natural rubber, (ii) ethylene propylene diene monomer (EPDM), (iii) styrene butadiene rubber (SBR, (iv) neoprene rubber and (v) any combination of any of (i), (ii), (iii) and (iv) material. In the present practice, where skin sheet stock is formed of thermoplastic elastomer, it has been found satisfactory to form the skin sheet stock of one of (i) polyurethane, (ii) styrene butadiene rubber (SBR), (iii) styrene ethylene butylene styrene (SEBS) and (iv) any combination of any of (i), (ii) and (iii) material. The pattern for the skin 20 is cut to the appropriate shape such that when wrapped and formed into a tube, it can be assembled and will fit over the outer surface of the underlist 10 between end flanges 12 and 16.

A suitable carrier which is formed as a relatively thin film 22 is provided with the desired logo or colored design of heat transferrable ink as denoted by reference numeral 24 in FIG. 3, one one surface of the carrier 22, which is cut to a pattern which will overlie the skin sheet pattern 20. In the present practice, it has been found satisfactory to use material such as polyethylene terephthalate (PET), polyamide or paper for the carrier 22. In the present practice, it has also been found satisfactory to use uncured rubber sheet having a thickness of about 0.3 to about 2.0 mm for the sheet stock 20; and, in one exemplary version of the skin sheet 20, the sheet material has a thickness of about 0.65 mm. The colored design or logo 24 is applied to the surface of the carrier 22 using curable flexible ink materials suitable for heat transfer printing onto the sheet 20.

Referring to FIG. 3, the uncured sheet 20 is shown as disposed in a fixture 26; and, the carrier 22 is disposed in a similar fixture 28 with the colored design or logo applied with heat transferable ink onto the exposed surface of the carrier 22. The fixtures 26, 28 may be connected by hinges 30, 32 which permit the fixtures 26, 28 to be closed as indicated by dashed line in FIG. 3 and sufficient closing forces exerted thereupon, such as in a press or by clamping, to cause the carrier 22 to be laminated on and adhere to the surface of the uncured rubber pattern 20 by virtue of the tackiness of the surface of the uncured rubber. The fixtures 26, 28 are then opened and the carrier 22 remains laminated onto the surface of the sheet stock 20; and, the laminate is then removed from the fixture 26 for further processing as will be hereinafter described.

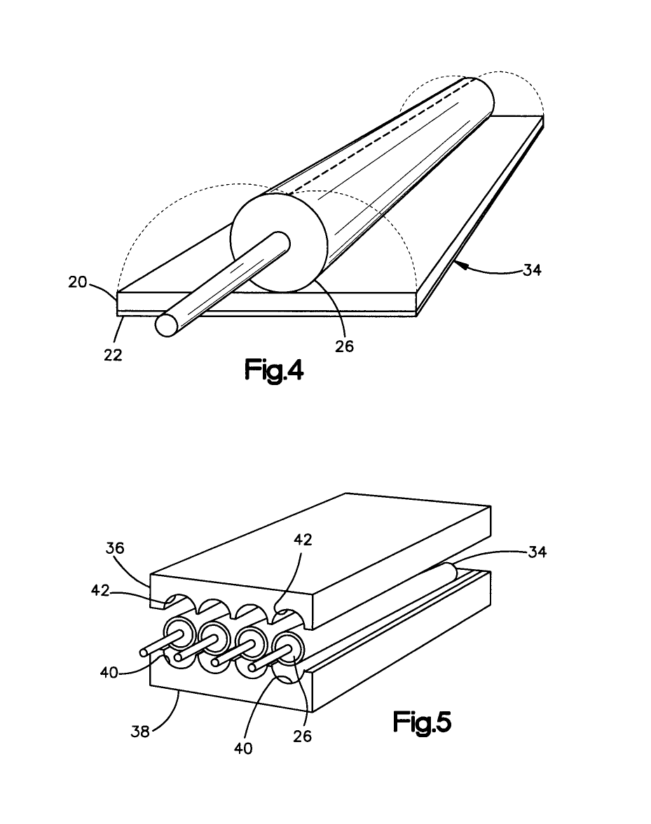

Referring to FIG. 4, the laminate with the carrier 22 attached to the surface of the sheet stock 20 is indicated generally at 34. The laminate 34 is then wrapped onto the surface of a core bar 36 with the carrier on the outer surface. The closing of the tubular laminate on the surface of the core bar is denoted by the dashed lines in FIG. 4. The configuration and dimensions of the core bar are chosen such that the sheet stock in tubular form, when cured, will have the appropriate size for assembly onto a particular underlist 10.

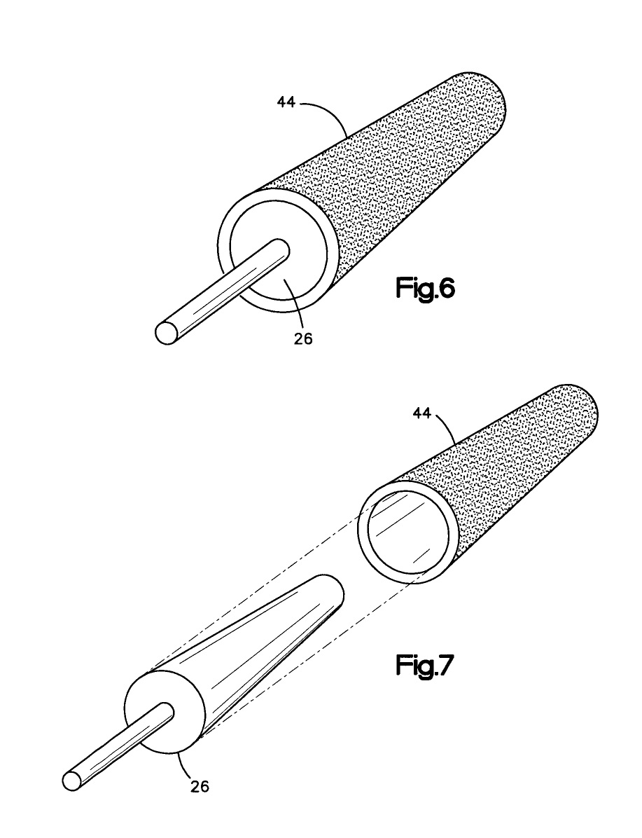

Referring to FIG. 5, the core bar with the laminate 34 wrapped thereon is shown with a plurality of such wrapped core bars disposed in a pair of mold halves 36, 38. The cavities denoted 40, 42 in the respective mold halves 38, 36 are formed with a desired textured surface and/or embossing to provide the desired outer surface of the completed grip. The core bars 26 with the wrapped laminate 34 wrapped thereon are then compression molded by closure of the mold halves 36, 38. Upon completion of the curing in the case of thermosetting sheet stock and heating in the case of thermoplastic sheet stock, the mold halves 36, 38 are separated and the core bars, with the cured laminate thereon, removed from the mold. In the present practice, it has been found satisfactory to cure the sheet stock 20 in the mold 26, 28 at a temperature of about 160° C. to about 180° C. for about 3 minutes. The core bars are removed resulting in a seamless tubular skin or sheath of cured material having the colored logo or design transferred thereto as shown in FIG. 6 denoted by reference numeral 44. The carrier 22 is removed from the cured sheet stock upon removal from the mold thereby leaving the colored design and/or logo transferred and cured upon the exposed surface of the cured sheet stock 20. The core bar is then removed leaving a seamless sheath or tubular member 44 as shown in FIG. 7.

The seamless cured tubular member 44 is then assembled onto the underlist 10 in the manner shown in FIG. 8 and the tubular member 44 is secured thereon; as, for example, by adhesive bonding to provide a complete grip indicated generally at 46 in FIG. 9 which is ready for assembly onto an implement handle 48 illustrated in dashed outline.

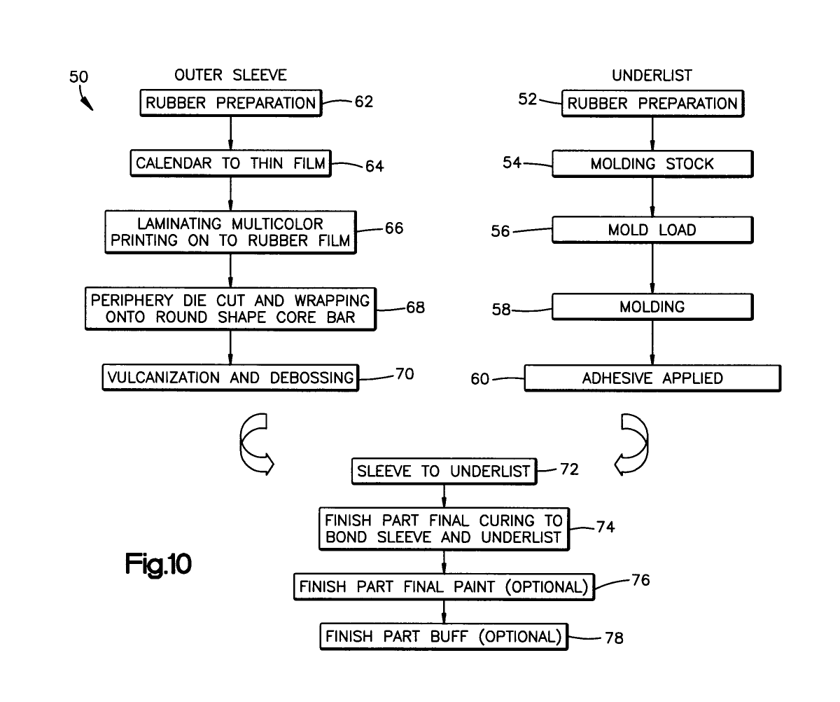

Referring to FIG. 10, the method of the present disclosure is indicated at block flow diagram generally at 50 wherein the underlist is formed by preparation of the elastomer or rubber at step 52 and sized or configured for mold insertion at step 54 for loading into a suitable mold at step 56. After curing or vulcanization in a mold denoted at 58, the cured underlist is removed from the mold and a suitable bonding adhesive applied at step 60.

Contemporaneously with the fabrication of the underlist at steps 52 through 60, the tubular sleeve is formed by preparation of the thermosetting or thermoplastic elastomer of the desired composition at step 62 and rolling or calendaring the material to the desired thickness at step 64. The sheet stock formed in step 64 then has the carrier with a desired logo or design applied thereto laminated thereon at step 66. The laminate from step 66 is then cut to a desired pattern and wrapped onto a shaped core bar at step 68. The core bar with the wrapped laminate of step 68 is then heated or cured in a mold having the appropriate texture provided in the cavities thereof at step 70.

The cured laminate or sleeve of step 70 is removed from the mold and core bar removed and the sleeve is assembled onto the underlist at step 72 and secured thereto by curing of the bonding adhesive at step 74. Optional painting and buffing of the finished grip may be performed respectively at steps 76 and 78, if desired. The finished grip of step 74 is otherwise ready for installation on the handle of an implement.

The present disclosure thus describes a unique method of making a flexible implement grip such as a golf club grip having a durable colored design and/or logo cured on the outer surface of the grip which may also include texture or embossing in a manner which is relatively low in cost and simple to fabricate. The method of the present disclosure utilizes a cured underlist with a tubular sheath of cured textured material assembled thereof and secured thereon such as by adhesive bonding. The sheath is formed of sheet stock laminated with a carrier having heat transferrable ink thereon, the laminate wrapped on a core bar and heat and compression molded to form a tubular sheath which is removed from the mold, the carrier and core bar removed, and the cured sheath or tubular member, assembled over the cured underlist and adhesively bonded thereto to provide a completed flexible grip with durable colored designs on the surface thereof.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of making a flexible grip for an implement handle comprising:
(a) forming a tubular underlist of one of (i) elastomeric and (ii) polymeric material and forming the underlist to a desired shape in a mold;
(b) providing a fixture and laminating a thin film carrier having a multi-colored graphic design of heat transferrable ink thereon in the fixture onto a sheet of uncured thermosetting elastomer and removing the laminated sheet from the fixture and wrapping the sheet about a core bar and forming a tubular sleeve therefrom;
(c) providing a mold and forming one of embossing surfaces and textured surfaces in the mold and inserting the core bar with the sheet wrapped thereon into the mold and seamlessly curing the sleeve in the mold and concurrently transferring the graphic design onto the sleeve;
(d) removing the core bar and sleeve from the mold and removing the carrier from the sleeve and exposing the multi-colored graphic design and molded surface and removing the core bar from the sleeve; and,
(e) assembling the cured sleeve over the underlist and securing the sleeve to the underlist.

2-3. (canceled)

4. The method of claim 1, wherein the disposing a thin film carrier includes disposing a film of one of (i) polyethylene terephthalate (PET), (ii) paper, and (iii) polyamide material.

5. (canceled)

6. The method of claim 1, wherein securing the sleeve to the underlist includes adhesive bonding.

7. The method of claim 1, wherein forming a sheet includes forming a sheet having a thickness in the range of about 0.3 mm to about 2.0 mm.

8. The method of claim 1, wherein forming a sleeve includes die cutting a pattern from the sheet and a pattern from the carrier and laminating the carrier pattern onto the sheet pattern.

9. The method of claim 1, wherein curing the underlist includes curing at a temperature in the range of about 160° to about 180 ° C. for about three minutes.

10. The method of claim 1, wherein forming a tubular sleeve includes wrapping the sheet on a core bar, compression molding and removing the core bar.

11. The method of claim 1, wherein forming a tubular underlist includes forming a tubular member having an end thereof closed.

12. (canceled)

13. The method of claim 1, wherein forming a tubular underlist includes forming an underlist of one of (i) ethylene vinyl acetate (EVA) foam, (ii) thermoplastic elastomer (TPE) foam, and (iii) elastomeric foam material.

14. The method of claim 1, wherein disposing a thin film carrier onto a sheet of the thermosetting elastomer includes disposing a thin film carrier onto a sheet of one of (i) natural rubber, (ii) ethylene propylene diene monomer (EPDM), (iii) styrene butadiene rubber (SBR), (iv) neoprene rubber and (iv) any combination of (i), (ii), (iii) and (iv).

15. A method of making a flexible grip for an implement handle comprising:
(a) forming a tubular underlist of one of (i) elastomeric and (ii) polymeric material and forming the underlist to a desired shape in a mold;
(b) providing a fixture and laminating a thin film carrier having a multi-colored graphic design of heat transferrable ink thereon in the fixture onto a sheet of thermoplastic elastomer and removing the laminated sheet from the fixture wrapping the sheet on a core bar and forming a tubular sleeve therefrom;
(c) providing a mold and inserting the core bar with the sheet wrapped thereon into the mold and forming one of embossing surfaces and textured surfaces in the mold and heating the sleeve in the mold and forming a seamless sleeve and concurrently transferring the graphic design onto the sleeve and conforming the surface of the sleeve to the surfaces in the mold during heating;
(d) removing the core bar sleeve from the mold and removing the carrier from the sleeve and exposing the multi-colored graphic design and molded surface and removing the core bar from the sleeve; and,
(e) assembling the sleeve over the underlist and securing the sleeve to the underlist.

16. (canceled)

17. (canceled)

18. (canceled)

19. The method of claim 15, wherein disposing a thin film carrier includes disposing a thin film of one of (i) polyethylene terephthalate (PET), (ii) paper and (iii) polyamide material.

20. (canceled)

21. The method of claim 15, wherein the securing the sleeve to the underlist includes adhesive bonding.

22. The method of claim 15, wherein the forming a tubular underlist includes forming a tubular member having an end thereof closed.

23. The method of claim 15, wherein forming a sleeve includes die cutting a pattern from the sheet and from the thin film carrier; and, inserting the pattern in a fixture and laminating the thin film carrier pattern onto the sheet pattern in the fixture and removing the laminate from the fixture.

24. The method defined in claim 15, wherein forming a tubular underlist includes forming an underlist of foam material.

25. The method of claim 24, wherein forming an underlist of foam material includes forming an underlist of one of (i) ethylene vinyl acetate (EVA) foam, (ii) thermoplastic elastomer (TPE) foam, and (iii) elastomer foam material.

26. The method of claim 15, wherein disposing a carrier on a sheet of thermoplastic elastomer includes disposing a thin film carrier on a sheet of one of (i) polyurethane, (ii) styrene butadiene rubber (SBR) and (ii) styrene ethylene butylene styrene.
